(19) United States
(12) Patent Application Publication
(10) Pub. No.: US 2004/0023081 A1
(43) Pub. Date: Feb. 5, 2004

(54) Fuel cell system, fuel pack, camera, portable telephone with camera and portable terminal

(75) Inventors: Seimei Ushiro, Saitama-ken (JP); Naoyuki Nishino, Saitama-ken (JP); Yoshihiro Ito, Saitama-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/631,894

(22) Filed: Aug. 1, 2003

(30) Foreign Application Priority Data
Aug. 2, 2002 (JP) 2002-225670
Mar. 31, 2003 (JP) 2003-95317

(51) Int. Cl. H01M 16/00; H01M 8/02

(52) U.S. Cl. 429/9; 429/34

(57) ABSTRACT

A fuel cell system including: a fuel cell; and a fuel pack including: a fuel storing section for storing a fuel for generating power by the fuel cell, a fuel supply port which is provided in the fuel storing section, and is connected to a solution supply port of a fuel electrode of the fuel cell, a discharged-solution storing section for storing solution discharged from the fuel cell, a discharged-solution recovery port which is provided in the discharged-solution storing section, and is connected to a solution discharge port of an air electrode of the fuel cell, and a sheet member which is deformable, and which separates the fuel storing section and the discharged-solution recovery section from each other. Further, a secondary cell which stores power generated by the fuel cell is installed.

### CROSS-REFERENCE TO RELATED APPLICATION

This application claims priority under 35 USC 119 from Japanese Patent Application Nos. 2002-225670 and 2003-95317, the disclosures of which are incorporated by reference herein.

### BACKGROUND OF THE INVENTION

1. Field of the Invention

The present invention relates to a fuel pack for storing fuel to be used in a fuel cell, a fuel cell system that is constituted by the fuel pack and the fuel cell and a camera that is provided with such a fuel cell system.

2. Description of the Related Art

Conventionally, fuel cells, which constantly generate power continuously, have been devised (for example, see Japanese Patent Application Laid-Open (JP-A) No. 6-163965). Among these fuel cells, those that have drawn public attention as a high capacity power supply for a portable device such as a digital camera are polymer electrolyte fuel cells (PEFC). Among these PEFCs, a direct methanol fuel cell (DMFC), which directly supplies a methanol aqueous solution to a cell, is suitable for miniaturization of a device since it requires no peripheral assistant devices such as a modifying device for forming hydrogen from methanol and a reformer used for controlling carbon dioxide concentration.

As shown in FIG. 14, in the DMFC, electricity is generated through a chemical reaction between the methanol aqueous solution (CH₃COOH+H₂O) and oxygen (O₂). A single cell 100, which is a minimum constituent unit, has a structure in which two electrodes, that is, an anode (fuel electrode) 104 and a cathode (air electrode) 106, sandwich a thin film that is referred to as a proton conductive membrane 102. The methanol aqueous solution serving as a fuel is decomposed into hydrogen ions (H⁺), electrons (e−) and carbon dioxide (CO₂) through a catalytic action of the anode 104.

At this time, power is generated by the generated electrons. Moreover, carbon dioxide is discharged from the anode 104. Hydrogen ions migrate through the proton conductive membrane 102 to be bonded to oxygen supplied to the cathode 106 so that water (H₂O) is formed, and discharged from the cathode 106.

For this reason, to utilize the DMFC as a power supply, not only the aqueous solution of methanol needs to be supplied as a power source, but also water that is a by-product needs to be recovered. Therefore, conventionally, a fuel cell system in which the by-product, generated in a fuel cell, is recovered has been proposed (for example, see JP-A No. 2003-36879).

However, since conventional fuel cell systems have failed to sufficiently prevent the by-product from leaking out, the generated byproduct, i.e., water and the like tend to leak out from the fuel cell system, causing problems, such as leak, deterioration in electronic parts and contact failure in terminals, in a precision electronic device such as a camera.

Moreover, since the application in cold districts has not been taken into consideration, the by-product has a possibility to freeze, causing a difficulty in taking the recovered by-product out from the fuel cell system.

Furthermore, the power generation of the fuel cell has not been properly controlled, with the result that power is excessively supplied to an electronic apparatus to wastefully consume the fuel.

### SUMMARY OF THE INVENTION

The present invention has been devised to solve the above-mentioned problems, and the object is to prevent a by-product generated in a fuel cell from leaking out or being frozen, as well as preventing a fuel from being wastefully consumed.

A first aspect of the present invention provides a fuel cell system comprising: a fuel cell; and a fuel pack including: a fuel storing section for storing a fuel for generating power by the fuel cell, a fuel supply port which is provided in the fuel storing section, and is connected to a solution supply port of a fuel electrode of the fuel cell, a discharged-solution storing section for storing solution discharged from the fuel cell, a discharged-solution recovery port which is provided in the discharged-solution storing section, and is connected to a solution discharge port of an air electrode of the fuel cell, and a sheet member which is deformable, and which separates the fuel storing section and the discharged-solution recovery section from each other, wherein a secondary cell which stores power generated by the fuel cell is installed.

In the above-mentioned fuel cell system, a fuel supply port is formed in a fuel storing section. The fuel supply port is connected to a solution supply port of a fuel electrode of the fuel cell. Thus, a fuel, stored in the fuel storing section, is supplied to the fuel electrode through the fuel supply port and the liquid supply port so that power is generated.

Moreover, a discharged-solution recovery port is formed in a discharged-solution storing section. The discharged-solution recovery port is connected to a solution discharge port of an air electrode of the fuel cell. Thus, a discharge solution generated at the air electrode is stored in the discharged-solution storing section through the solution discharge port and the discharged-solution recovery port.

Here, the fuel storing section and the discharged-solution storing section are separated by a sheet member that is deformable so that the capacities of the fuel storing section and the discharged-solution storing section can be freely changed. For this reason, the capacity of the fuel storing section prior to supply of fuel to the fuel cell is expanded by the stored fuel, with the capacity of the discharged-solution storing section being comparatively reduced.

However, when a fuel pack is attached to a fuel cell so that the fuel is consumed, the fuel in the fuel storing section reduces with the capacity of the fuel storing section being reduced, while the capacity of the discharged-solution storing section is relatively expanded. For this reason, a sufficient space for recovering a discharge solution discharged from the fuel cell is prepared in the fuel pack.

As described above, by separating the discharged-solution storing section and the fuel storing section using the deformable sheet member, it becomes possible to install the discharged-solution storing section and the fuel storing section in the same space within the fuel pack. Therefore, it becomes possible to miniaturize the fuel pack, and also to eliminate the necessity of a discharge tank to be attached to an electronic device provided with a fuel cell.

Here, power, generated in the fuel cell, is stored in a secondary cell. For this reason, the fuel cell is allowed to generate power only when the power of the secondary cell is insufficient. Thus, it becomes possible to prevent an excessive supply of power and subsequent wasteful consumption of fuel.

According to the first aspect, the fuel cell system may be adapted such that an antifreezing agent is provided in the discharged-solution storing section.

In the above-mentioned fuel cell system, an antifreezing agent is provided in the discharged-solution storing section. For this reason, even when the fuel pack is used in a cold district having temperatures under freezing point, the discharge solution recovered in the discharged-solution storing section does not freeze. Therefore, even in the case of application in such a cold district, it is possible to take out the discharge solution stored in the discharged-solution storing section, and consequently to maintain a space used for refilling the fuel in the fuel storing section; thus, the fuel pack can be continuously used.

Moreover, the fuel cell system may be adapted such that the antifreezing agent is filled into the discharged-solution storing section.

The discharged-solution storing section is filled with the antifreezing agent. When the antifreezing agent becomes old, the antifreezing agent can be taken out of the discharged-solution storing section, with a new antifreezing agent being filled into the discharged-solution storing section. Thus, the changing operation of the antifreezing agent can be easily carried out.

Furthermore, the fuel cell system may be adapted such that the antifreezing agent is applied to coat the discharged-solution storing section.

Since the discharged-solution storing section is coated with the antifreezing agent, it is possible to prevent the discharge solution recovered in the discharged-solution storing section from being frozen. Moreover, different from granular antifreezing agent, the antifreezing agent of this type requires no changing operation.

The fuel cell system may be adapted such that a desiccant is filled into the discharged-solution storing section.

A desiccant is filled into the discharged-solution storing section. Therefore, the discharged solution recovered in the discharged-solution storing section as water vapor is adsorbed by the desiccant. Therefore, since the discharge solution needs not to be stored in the discharged-solution storing section as liquid, it is possible to prevent the discharge solution from leaking out from the discharged-solution storing section, and consequently to prevent problems, such as leak, deterioration in electronic parts and contact failure in terminals, from occurring in an electronic device such as a camera.

The fuel cell system may further comprise a discharged-solution bag into which the desiccant is filled wherein the discharged-solution storing section is formed by detachably attaching an opening portion of the discharged-solution bag to the discharged-solution recovery port.

The fuel storing section and the discharged-solution storing section are separated from each other by the sheet member comprising a flexible material. Therefore, prior to supply of fuel to the fuel cell, the capacity of the fuel storing section is expanded by the sheet member that is allowed to expand by the stored fuel. In comparison with the above, the capacity of the discharged-solution storing section is reduced.

However, when the fuel pack is attached to the fuel cell so that the fuel is consumed, the amount of the fuel in the fuel storing section is reduced, with the result that the sheet member is allowed to shrink, thereby reducing the capacity of the fuel storing section, with the capacity of the discharged-solution storing section being relatively expanded. For this reason, it is possible to maintain a sufficient space to be used for recovering a discharge solution discharged from the fuel cell in the fuel pack.

In the fuel cell system, the sheet member may comprise a flexible material.

The fuel storing section and the discharged-solution storing section are separated from each other by the sheet member comprising a flexible material. Therefore, prior to supply of fuel to the fuel cell, the capacity of the fuel storing section is expanded by the sheet member that is allowed to expand by the stored fuel. In comparison with this, the capacity of the discharged-solution storing section is reduced.

However, when the fuel pack is attached to the fuel cell so that the fuel is consumed, the amount of the fuel in the fuel storing section is reduced, with the result that the sheet member is allowed to shrink, thereby reducing the capacity of the fuel storing section, with the capacity of the discharged-solution storing section being relatively expanded. For this reason, it is possible to maintain a sufficient space to be used for recovering a discharge solution emitted from the fuel cell in the fuel pack.

Further, the sheet member may comprise an alcohol resistant material

The fuel storing section and the discharged-solution storing section are separated from each other by a sheet material having an alcohol-resistant property. For this reason, this material is less susceptible to deterioration due to alcohol such as methanol serving as a fuel of the fuel cell.

Moreover, the fuel cell system has an arrangement in which the fuel storing section is formed from a bag body, and a flexible casing which comprises the fuel supply port and the discharged-solution recovery port, houses the bag body, and forms the discharged-solution storing section on the outside of the bag.

In the above-mentioned fuel cell system, the inner side of the fuel bag body is used as the fuel storing section with the outside of the fuel bag body being used as the discharged-solution storing section. Therefore, it is not necessary to provide a special partition in the casing.

Moreover, it is only necessary to apply pressure to the flexible casing so as to raise the inner pressure of the casing to send the fuel to the fuel electrode through the fuel supply port and the solution supply port from the bag body. When the pressure application to the casing is stopped, the inner pressure of the casing drops so that the discharged solution is recovered to the casing through the solution discharge port and the discharge supply port from the air electrode.

The fuel cell system may further comprise a heating mechanism which heats at least one of the discharge solution stored in the discharged-solution storing section and the discharged solution stored in the casing.

The discharged solution, stored in the discharged-solution storing section, is heated by a heating mechanism in order to prevent the discharged solution from being frozen. Here, the fuel cell may be heated by the heating mechanism. Thus, even in the case when the utilized fuel cell is a type of a fuel cell, which cannot generate power in cold districts, the chemical reaction is accelerated so that power is generated.

A second aspect of the invention provides a fuel pack comprising: a fuel bag body which stores a fuel to be used for generating power in a fuel cell; a fuel supply port which is provided at an opening portion of the fuel bag body, and connected to a solution supply port of a fuel electrode of the fuel cell; a flexible casing that houses the fuel bag body storing the fuel; and a discharged-solution recovery port which is provided at the casing, and connected to a solution discharge port of an air electrode of the fuel cell.

In the above-mentioned fuel pack, the inner side of the fuel bag body is used as the fuel storing section with the inner side of the casing being used as the discharged-solution storing section. Therefore, it is not necessary to provide a special partition in the casing.

Moreover, it is only necessary to apply a pressure to the flexible casing so as to raise the inner pressure of the casing to send the fuel to the fuel electrode through the fuel supply port and the solution supply port from the bag body. When the pressure application to the casing is stopped, the inner pressure of the casing drops so that the discharged solution is recovered to the casing through the solution discharge port and the discharge supply port from the air electrode.

The fuel pack of the second aspect may have a desiccant is filled into the casing.

In the above-mentioned fuel pack, a desiccant is filled into the casing. Therefore, the discharged solution to be recovered in the casing as water vapor is adsorbed by the desiccant. Thus, since the discharge solution needs not be stored in the discharged-solution storing section as liquid, it is possible to prevent the discharge solution from leaking out of the discharged-solution storing section, and consequently to prevent problems such as leak in an electronic device like a camera, deterioration in electronic parts and contact failure in terminals.

The fuel pack of the second aspect may further comprise a discharge solution bag which is housed in the casing with an opening portion thereof being detachable attached to the discharged-solution recovery port, and into which the desiccant is filled.

In the above-mentioned fuel pack, a desiccant is filled into a discharge solution bag. The opening portion of the discharge solution bag of which is detachably attached to the discharged-solution recovery port is housed in the casing. Therefore, even when the amount of the discharged solution recovered into the discharge solution bag increases to make the desiccant no longer adsorb water vapor, not only the desiccant but also the discharge solution bag as a whole may be changed. Thus, it becomes possible to easily change the desiccant.

Further, the casing may be provided with an antifreezing agent.

In the above-mentioned fuel pack, the antifreezing agent is provided to the casing. Therefore, even when the fuel pack is used in a cold district having temperatures under freezing point, the discharged solution recovered in the discharged-solution storing section does not freeze. Therefore, even in the case of application in such a cold district, it is possible to take out the discharge solution stored in the discharged-solution storing section, and consequently to maintain a space used for refilling the fuel in the fuel bag body. Thus, the fuel pack can be continuously used.

A third aspect of the invention provides a fuel pack comprising: a fuel storing section for storing a fuel for generating power by a fuel cell; a fuel supply port which is provided in the fuel storing section, and is connected to a solution supply port of a fuel electrode of the fuel cell; a discharged-solution storing section for storing solution discharged from the fuel cell; a discharged-solution recovery port which is provided in the discharged-solution storing section, and is connected to a solution discharge port of an air electrode of the fuel cell; and a sheet member which is deformable, and which separates the fuel storing section and the discharged-solution recovery section from each other, wherein a desiccant is filled into the discharged-solution storing section.

In the above-mentioned fuel pack, a fuel supply port is formed in a fuel storing section. This fuel supply port is connected to a solution supply port of the fuel electrode of the fuel cell. Therefore, the fuel, stored in the fuel storing section, is supplied to the fuel electrode through the fuel supply port and the solution supply port so that power is generated.

Moreover, a discharged-solution recovery port is formed in the discharged-solution storing section. The discharged-solution recovery port is connected to a solution discharge port of the air electrode of the fuel cell. Thus, the discharge solution generated at the air electrode is stored in the discharged-solution storing section through the solution discharge port and the discharged-solution recovery port.

Here, the fuel storing section and the discharged-solution storing section are separated from each other by a deformable sheet member so that the capacities of the fuel storing section and the discharged-solution storing section can be freely changed. For this reason, the capacity of the fuel storing section prior to supply of fuel to the fuel cell is expanded by the stored fuel, with the capacity of the discharged-solution storing section being comparatively reduced.

However, when a fuel pack is attached to a fuel cell so that the fuel is consumed, the fuel in the fuel storing section reduces with the capacity of the fuel storing section being reduced, while the capacity of the discharged-solution storing section is relatively expanded. For this reason, a sufficient space for recovering a discharge solution discharged from the fuel cell is provided in the fuel pack.

As described above, by separating the discharged-solution storing section and the fuel storing section using the deformable sheet member, it becomes possible to provide the discharged-solution storing section and the fuel storing section in the same space within the fuel pack. Therefore, it becomes possible to miniaturize the fuel pack, and also to eliminate the necessity of a discharge tank to be attached to an electronic device provided with a fuel cell.

Moreover, a desiccant is filled into the discharged-solution storing section. Therefore, the discharged solution to be recovered in the discharged-solution storing section as water vapor is adsorbed by the desiccant. Thus, since the discharge solution needs not to be stored in the discharged-solution storing section as liquid, it is possible to prevent the discharge solution from leaking out of the discharged-solution storing section, and consequently to prevent problems, such as leak, deterioration in electronic parts and contact failure in terminals, from occurring in an electronic device such as a camera.

In the fuel pack according to the third aspect, the desiccant may be filled into the discharge solution bag. Further, the opening portion of the discharge solution bag of which is detachably attached to the discharged-solution recovery port is housed in the discharged-solution storing section. Therefore, even when the amount of the discharge solution recovered into the discharge solution bag increases to make the desiccant no longer adsorb water vapor, not only the desiccant but also the discharge solution bag as a whole may be changed. Thus, it becomes possible to easily change the desiccant.

A fourth aspect of the invention provides a fuel pack comprising: a fuel storing section for storing a fuel for generating power by a fuel cell; a fuel supply port which is provided in the fuel storing section, and is connected to a solution supply port of a fuel electrode of the fuel cell; a discharged-solution storing section for storing solution discharged from the fuel cell; a discharged-solution recovery port which is provided in the discharged-solution storing section, and is connected to a solution discharge port of an air electrode of the fuel cell; and a sheet member which is deformable, and separates the fuel storing section and the discharged-solution recovery section from each other, wherein the discharged-solution storing section is provided with an antifreezing agent.

In the above-mentioned fuel pack, an antifreezing agent is provided in the discharged-solution storing section. For this reason, even when the fuel pack is used in a cold district having temperatures under freezing point, the discharged solution recovered in the discharged-solution storing section does not freeze. Therefore, even in the case of application in such a cold district, it is possible to take out the discharge solution stored in the discharged-solution storing section, and consequently to maintain a space used for refilling the fuel in the fuel storing section. Thus, the fuel pack can be continuously used.

In the fourth aspect, the discharged-solution storing section may be filled with an antifreezing agent. When the antifreezing agent becomes old, the antifreezing agent can be taken out of the discharged-solution storing section, with a new antifreezing agent being filled in the discharged-solution storing section. thus, the changing operation of the antifreezing agent can be easily carried out.

Alternately, the discharged-solution storing section may be coated with the antifreezing agent. In this case, it is possible to prevent the discharge solution recovered in the discharged-solution storing section from being frozen. Moreover, different from granular antifreezing agent, the antifreezing agent of this type requires no changing operation.

In the fuel pack of the fourth aspect, the fuel storing section and the discharged-solution storing section are separated by a sheet member made from a flexible material so that the capacities of the fuel storing section and the discharged-solution storing section can be freely changed. For this reason, the capacity of the fuel storing section prior to supply of fuel to the fuel cell is expanded by the sheet member that is allowed to expand due to the stored fuel, with the capacity of the discharged-solution storing section being comparatively reduced.

### BRIEF DESCRIPTION OF THE DRAWINGS

FIG. 1 is a perspective view showing a fuel pack relating to the first embodiment of the present invention.

FIG. 2 is a circuit diagram of a digital camera provided with the fuel pack relating to the first embodiment of the invention.

FIG. 3 is a cross-sectional view that shows the fuel pack and a fuel cell relating to the first embodiment of the invention.

FIG. 4 is a cross-sectional view that shows a modified example of the fuel pack and the fuel cell of the first embodiment.

FIG. 5 is a cross-sectional view that shows a fuel pack relating to the second embodiment of the invention.

FIG. 6 is a cross-sectional view that shows a fuel pack relating to the third embodiment of the invention.

FIG. 7 is a perspective view showing the fuel pack of FIG. 6.

FIG. 8 is a cross-sectional view showing a fuel pack relating to the fourth embodiment of the invention.

FIG. 9A is a perspective view that shows a discharge solution bag which is used in the fuel pack of the fourth embodiment of the invention.

FIG. 9B is a perspective view that shows the fuel pack of the fourth embodiment from which a casing is removed.

FIG. 9C is a perspective view that shows the fuel pack of FIG. 9B to which the casing is attached.

FIG. 9D is a perspective view that shows a state in which the casing is attached to the fuel pack of FIG. 9C.

FIG. 10 is a cross-sectional view that shows a fuel pack relating to the fifth embodiment of the invention.

FIG. 11 is a cross-sectional view that shows a fuel pack relating to the sixth embodiment of the invention.

FIG. 12 is a perspective view that shows a fuel cell system relating to the seventh embodiment of the present invention.

FIG. 13 is a perspective view that shows a portable telephone provided with the fuel pack of FIG. 1.

FIG. 14 is a diagram that shows the principle of power generation in a direct methanol fuel cell.

### DETAILED DESCRIPTION OF THE INVENTION

Hereinafter, embodiments of the present invention will be described with reference to the drawings.

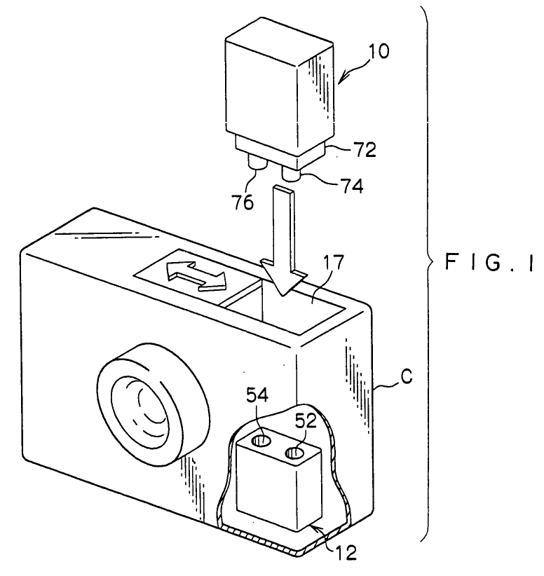

As shown in FIG. 1, a fuel pack 10, filled with a methanol aqueous solution (CH₃COOH+H₂O), is loaded to a housing section 17 which is provided in a digital camera C from above. A direct methanol fuel cell (hereinafter, referred to as fuel cell) 12, which generates power through a chemical reaction between the methanol aqueous solution and oxygen (O₂), and produces water (H₂O) as a by-product, is disposed on the bottom of the housing section 17. This fuel cell 12 and the fuel pack 10 are connected to each other in a watertight state, with a fuel supply port 74 being fitted to a solution supply port 52 and a discharged-solution recovery port 76 being fitted to a solution discharge port 54.

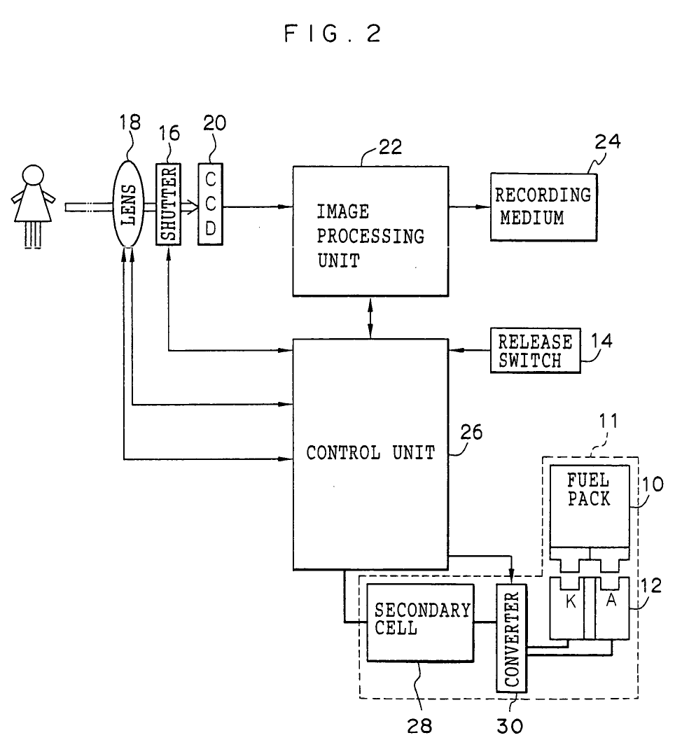

FIG. 2 shows a circuit diagram of a digital camera C relating to the present embodiment.

When a release switch 14 is pushed, a shutter 16 is opened and light rays entered through a lens 18 are converged at a charge coupled device (CCD) 20 to form an image thereon, and the resulting optical data is converted to electrical image data. The image data is transmitted to an image processing unit 22, and subjected to image processing therein. The image data that has been processed in the image processing unit 22 is stored in a recording medium 24.

The respective sections that form the digital camera C are controlled by a control unit 26. A secondary cell 28, which forms a fuel cell system 11 together with the fuel pack 10 and the fuel cell 12, is connected to the control unit 26. The respective sections forming the digital camera C are activated by electrical energy buffered in the secondary cell 28.

When the electrical energy buffered in the secondary cell 28 is insufficient, the control unit 26 activates a converter 30 to generate power in the fuel cell 12. After electrical energy has been supplied from the fuel cell 12 to complete the charging process of the secondary cell 28, the converter 30 is stopped so as to stop the power generation of the fuel cell 12.

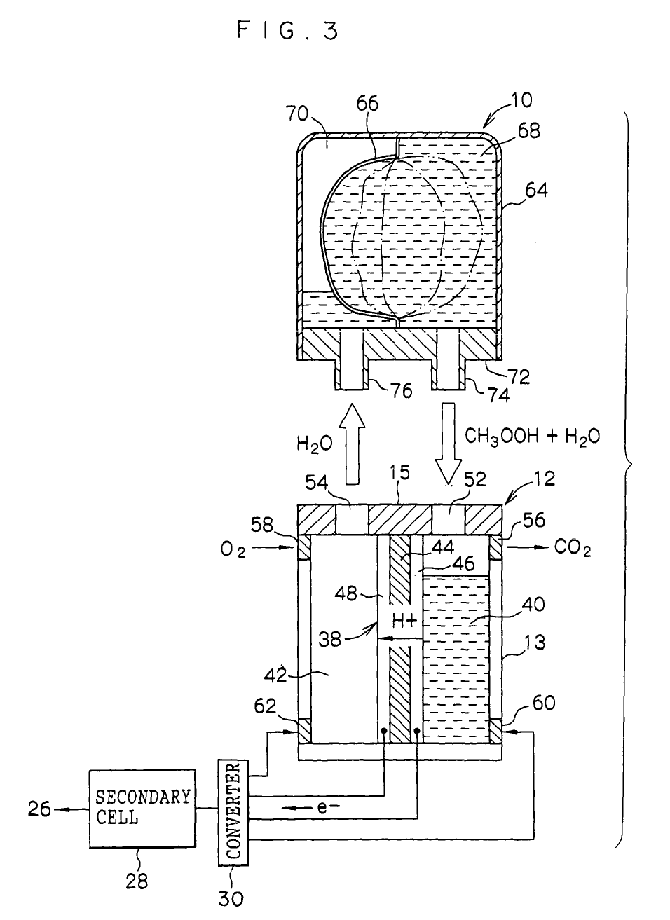

The structure of the fuel cell 12 will now be described. As shown in FIG. 3, plywood 38 is placed in the center of a box-shaped casing 13 that forms the fuel cell 12. The fuel cell 12 has a two-tank structure separated by the plywood 38. One of the tanks forms a fuel tank 40 to which a methanol aqueous solution is supplied, while the other tank forms an air tank 42 to which oxygen is supplied.

Moreover, the plywood 38 is formed by sandwiching a proton conductive membrane 44 by an anode 46 serving as a fuel electrode and a cathode 48 serving as an air electrode. The anode 46 forms a part of the fuel tank 40, and the cathode 48 forms a part of the air tank 42.

Here, a receiving base 15 on which the fuel pack 10, which will be described later, is mounted is provided on an upper portion of the casing 13. A solution supply port 52, which allows supply of a solution to the fuel tank 40, is formed in the receiving base 15, and a solution discharge port 54, which allows discharge of a solution from the air tank 42, is also formed therein.

Further, filters 56, 58 are provided on upper portions of the fuel tank 40 and the air tank 42. Moreover, pressure valves 60, 62 are provided on lower portions of the fuel tank 40 and the air tank 42. Each of these pressure valves 60, 62 are operated by the converter 30 so that the inner pressure of the fuel tank 40 or the air tank 42 is changed.

Next, the structure of the fuel pack 10 will be described. As shown in FIG. 3, the fuel pack 10 is provided with a casing 64. This casing 64 has a rectangular pillar shape, with one of the top faces in the longitudinal direction being opened. A cap 72 is attached to the opening portion of the casing 64 so that the opening portion is sealed by the cap 72.

The fuel supply port 74 which is connected to the solution supply port 52 of the fuel cell 12 and the discharged-solution recovery port 76 which is connected to the solution discharge port 54 are formed in the cap 72. Each of the fuel supply port 74 and the discharged-solution recovery port 76 has a special shape so that the solution will not go in or out of the casing 64 unless the inner pressure of the casing 64 or the casing 13 of the fuel cell 12 is changed. For this reason, when the fuel pack 10 is loaded in the housing section 17 the methanol solution or the like inside the casing 64 does not leak from the fuel supply port 74 and the discharged-solution recovery port 76.

Moreover, in the center of the casing 64 in the width direction (i.e., the left-right direction of FIG. 3), a sheet material 66 made of a material having flexibility and an alcohol resistant property (for example, Teflon ® rubber) is disposed therein. The casing 64 is separated by the sheet material 66, and thus, is formed into a structure having two tanks.

The tank having the fuel supply port 74 is a fuel storing section 68 for storing a methanol aqueous solution, and the tank having the discharged-solution recovery port 76 is a discharged-solution storing section 70 for storing water generated in the fuel cell 12. Since the sheet member 66, which forms a part of each of the fuel storing section 68 and the discharged-solution storing section 70, has an alcohol resistant property, the sheet member 66 will not deteriorate due to the methanol aqueous solution.

Moreover, the fuel storing section 68 and the discharged-solution storing section 70 are respectively sealed by the cap 72, the sheet member 66 and the casing 64. For this reason, mixture of the methanol aqueous solution in the fuel storing section 68 and water in the discharged-solution storing section 70 does not occur.

Now, the operations of the fuel pack 10 and the fuel cell 12 will be described.

First, the cap 72 of the fuel pack 10 is removed and the fuel storing section 68 is filled with a methanol aqueous solution. Since the sheet member 66 has flexibility, the sheet member 66 is warped toward the discharged-solution storing section 70 side as the amount of the methanol aqueous solution increases. In this manner, the capacity of the fuel storing section 68 can be expanded. Therefore, even when the discharged-solution storing section 70 is provided in the fuel pack 10, there is no possibility that the space for storing the methanol aqueous solution will be narrowed.

The fuel pack 10, filled with the methanol aqueous solution, is loaded in the digital camera C, and connected to the fuel cell 12. When it is detected that the fuel pack 10 is loaded, the control unit 26 controls the converter 30 to operate the pressure valve 60 of the fuel tank 40 in the fuel battery 12 so that the pressure inside the fuel tank 40 is reduced. Thus, the methanol aqueous solution is supplied to the fuel tank 40 through the fuel supply port 74 and the solution supply port 52 from the fuel storing section 68 of the fuel pack 10.

When the methanol aqueous solution is supplied to the fuel tank 40, the control unit 26 controls the converter 30 to apply a voltage to the anode 46 and the cathode 48. Thus, the methanol aqueous solution is decomposed into electrons (e−), carbon dioxide (CO₂) and hydrogen ions (H⁺) through a catalytic function of the anode 46.

Thus, power generation due to the generation of electrons is carried out, and these electrons are transferred to the secondary cell 28 to be buffered therein so that the secondary cell 28 is charged. Moreover, carbon dioxide is discharged from the filter 56 of the fuel tank 40. Here, an air hole, not shown, is formed in the digital camera C so that carbon dioxide can be discharged out of the camera through the air hole.

The hydrogen ions transmit through the proton conductive membrane 44 to the cathode 48. Oxygen (O₂) is supplied to the air tank 42 via the filter 58, and oxygen and the hydrogen ions are bonded to each other at the cathode 48 and generate water (H₂O), which is stored in the air tank 42.

In this case, the controller unit 26 controls the converter 30 to operate the pressure valve 62 of the air tank 42 and makes the interior pressure of the air tank 42 high. Thus, the water stored in the air tank 42 is subjected to pass through the solution discharge port 54 and the discharged-solution recovery port 76 from the air tank 42, and is recovered in the discharged-solution storing section 70 of the fuel pack 10.

At this time, since the methanol aqueous solution inside the fuel storing section 68 is supplied in the fuel cell 12 and the amount thereof is reduced, the sheet member 66 is contracted and the capacity of the fuel storing section 68 is reduced. Relatively, since the capacity of the discharged-solution storing section 70 is expanded, a sufficient space is maintained so as to recover water therein.

When the fuel cell 12 is operated to use all of the methanol aqueous solution inside the fuel pack 10, a sensor (not shown) detects the lack of fuel and emits a warning signal. Upon receipt of the warning signal, the fuel pack 10 is taken out of the digital camera C, and the cap 72 is removed to take water stored in the discharged-solution storing section 70 out. The fuel storing section 68 is filled again with a methanol aqueous solution, and the cap 72 is closed, and then, the fuel pack 10 is loaded to the digital camera C in order to charge the secondary cell 28.

As described above, since the fuel storing section 68 and the discharged-solution storing section 70 are separated from each other by the sheet member 66 made of a flexible material, the fuel storing section 68 and the discharged-solution storing section 70 can be provided at the same space in the interior of the fuel pack 10. Therefore, it is possible to miniaturize the fuel pack 10, and consequently to miniaturize the digital camera C. Moreover, this arrangement makes it possible to eliminate a space used for recovering water in the digital camera C.

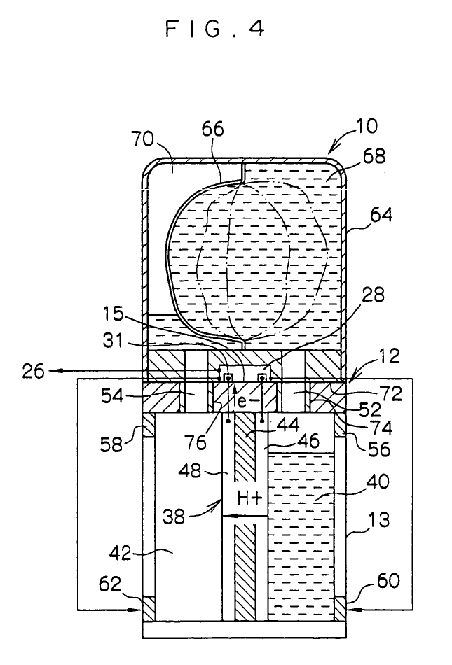

As shown in FIG. 4, the secondary cell 28 including the circuit of the converter 30 may be disposed at the cap 72 of the fuel pack 10, with terminals 31, which are connected to the fuel electrode 46 and the air electrode 48 (one terminal being + and the other terminal being −) disposed at a receiving base 15 of the fuel cell 12. In this case, when the fuel pack 10 is attached to the fuel cell 12, the terminals 31 are connected to the secondary cell 28.

Next, a fuel pack 80 relating to a second embodiment will be described. Here, members that are the same as those of the first embodiment are represented by the same reference numerals, and the description thereof is omitted.

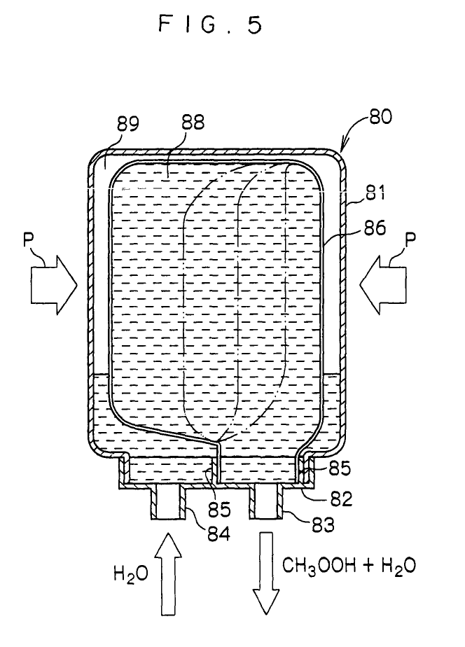

As shown in FIG. 5, the fuel pack 80 is provided with a casing 81 having a rectangular pillar shape. The casing 81 is made from a flexible material. Moreover, one end portion thereof in the length direction, is narrowed to become thinner, and is provided with a cap 82 detachably attached thereto.

The cap 82 is provided with a fuel supply port 83 and a discharged-solution recovery port 84. Further, on the periphery of the fuel supply port 83, which is located at the inner side of the cap 82, a round rib 85 is disposed thereof. An opening portion 87 of a bag 86 is attached to the rib 85, and the bag 86 is housed in the casing 81.

In the above-mentioned structure, the interior of the bag 86 is a fuel storing section 88 for storing a methanol aqueous solution, and the interior of the casing 81 is a discharged-solution storing section 89 that stores water recovered from the fuel cell. This arrangement eliminates the necessity of a special partition inside the casing 81.

Moreover, since the casing 81 is flexible, the inner pressure of the casing 81 increases by only applying pressure P thereto, and the methanol aqueous solution inside the bag 86 is sent through the fuel supply port 83 to the fuel cell.

Furthermore, first increasing the inner pressure of the casing 81 by applying pressure thereto, and then stop the application of the pressure P to decrease the inner pressure of the casing 81, it is possible to suck up water generated in the fuel cell as a by-product through the discharged-solution recovery port 84.

Next, a fuel pack 90 relating to a third embodiment will be described. Here, members that are the same as those of the first and second embodiments are represented by the same reference numerals, and the description thereof is omitted.

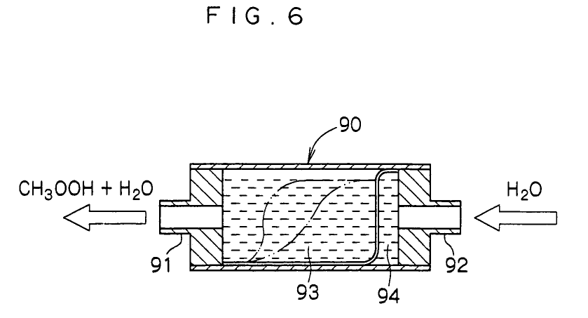

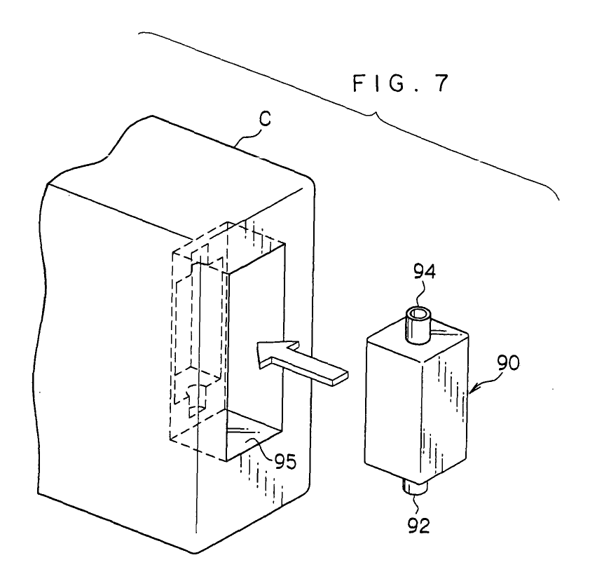

As shown in FIG. 6, in the fuel pack 90, a fuel supply port 91 and a discharged-solution recovery port 92 are disposed in alignment on the same straight line via a the fuel storing section 93 and a discharged-solution storing section 94. As shown in FIG. 7, the fuel pack 90 is loaded to a housing section 95 from a side face of the digital camera C.

Next, a fuel pack 100 in accordance with a fourth embodiment will be described. Here, members that are the same as those of the first to third embodiments are represented by the same reference numerals, and the description thereof is omitted.

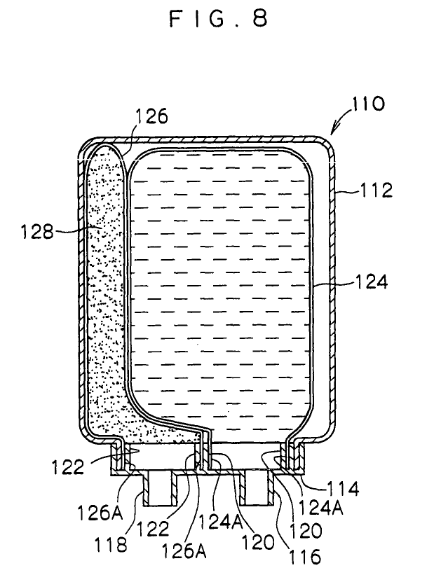

As shown in FIG. 8, the fuel pack 100 is provided with a casing 112. The casing 112 has a rectangular pillar shape with one of the top faces in the longitudinal direction being opened. A cap 114 is attached to the opening portion of the casing 112, and the opening portion is sealed.

The cap 114 is provided with a fuel supply port 116 and a discharged-solution recovery port 118. Further, on the periphery of the fuel supply port 116 and the discharged-solution recovery port 118 at the inner side of the cap 114, ribs 120 and 122, each having a rectangular shape, are formed. An opening portion 124A of a fuel bag body 124 serving as a fuel storing section is secured to the rib 120. An opening portion 126A of the discharge solution bag 126 serving as a discharged-solution storing section is detachably attached to the rib 122. The fuel bag body 124 and discharge solution bag 126 are housed in the casing 112.

The discharge solution bag 126 is filled with a granular desiccant 128 such as silica gel or the like. Each particle of the desiccant 128 has fine pores and physically adsorb water vapor that is sent to the discharge solution bag 126 from the fuel cell 12 (see FIG. 3). Thus, it is not necessary to store water recovered from the fuel cell 12 in the discharge solution bag 126 as liquid. In this way it possible to prevent water from leaking out from the fuel pack 100, and consequently to prevent problems, such as leak, deterioration in electronic parts and contact failure in terminals, from occurring in the digital camera C (see FIG. 1).

Here, the process to change the desiccant 128 will be described.

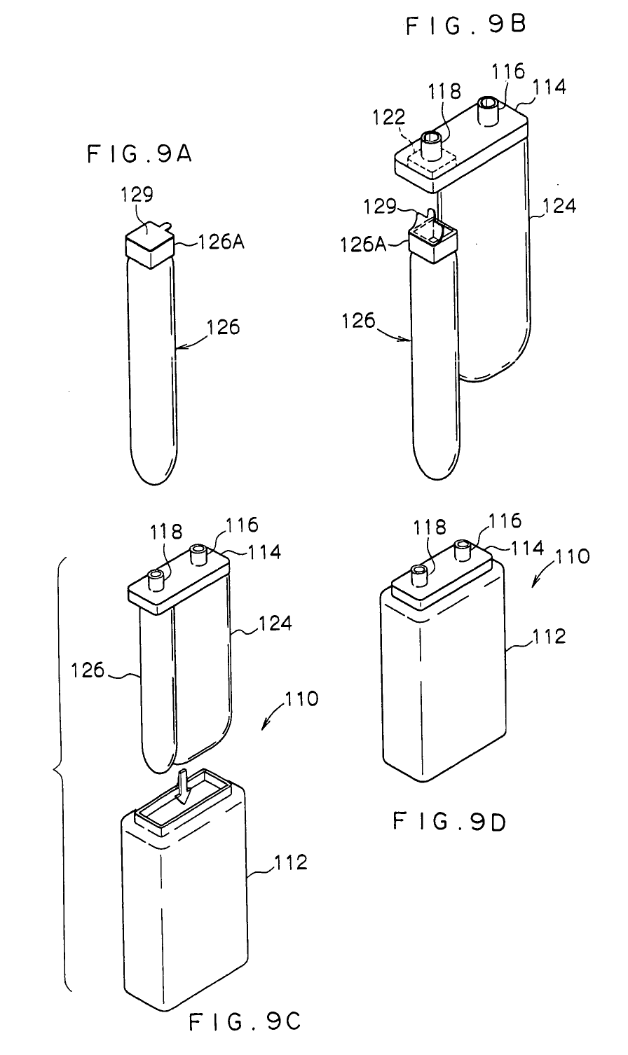

Change of the desiccant 128 is carried out when every predetermined times of fuel refilling operations are carried out. First, the number of fuel-refilling operations is counted by the control unit 26 (see FIG. 2), and when the fuel, which is refilled at the predetermined number of times, has been consumed, a warning signal that urges the replacement of the desiccant 128 is emitted together with a warning signal for urging the refill of the fuel. When the warning signals are emitted, the fuel pack 100 is taken out of the digital camera C (see FIG. 1), the cap 114 is removed from the casing 112, and the opening portion 126A of the discharge solution bag 126 is removed from the rib 122. Next, the old discharge solution bag is changed to a new discharge solution bag 126 as shown in FIG. 9A.

A seal member 129 is adhered to the opening portion 126A of the discharge solution bag 126, and the desiccant 128 (see FIG. 7) is sealed in the discharge solution bag 126. As shown in FIG. 9B, after removing the seal member 129 from the opening portion 126A, the opening portion 126A is attached to the rib 122. Then, as shown in FIGS. 9C and 9D, the fuel bag body 124 and the discharge solution bag 126 are inserted into the casing 112, and the cap 114 is attached to the opening portion of the casing 112.

In this manner, not only the desiccant 128 but also the discharge solution bag 126 is changed together therewith so that the changing operation of the desiccant 128 can be easily carried out.

Next, a fuel pack 130 in accordance with a fifth embodiment will be described. Here, members that are the same as those of the first to fourth embodiments are represented by the same reference numerals, and the description thereof is omitted.

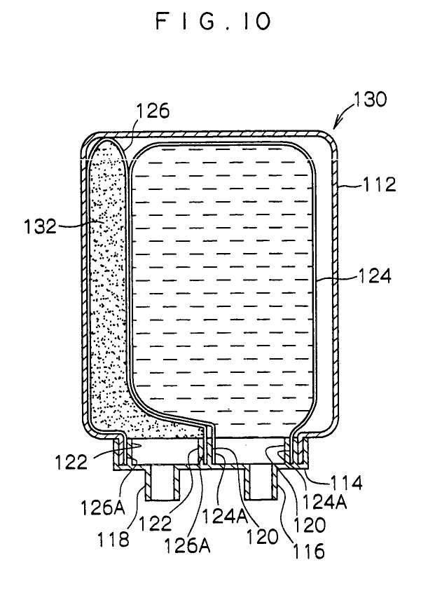

As shown in FIG. 10, a granular antifreezing agent 132 such as sodium chloride and calcium chloride is filled in the discharge solution bag 126 of the fuel pack 130 in place of the desiccant 128 of the third embodiment. Therefore, even in a cold district having temperatures below the freezing point, water, recovered from the fuel cell 12 (see FIG. 3) into the discharge solution bag 126, does not freeze. Thus, water stored in the discharge solution bag 126 can be taken out from the bag 126, and the fuel pack 130 can be used continuously.

Note that, an antifreezing agent 132 can be directly filled into the casing 112 indtead of filling the antifreezing agent 132 into the discharge solution bag 126, and also, in a case in which the casing 112 is made of metal, the antifreezing agent 132 may be formed by coating the surface of sodium chloride and calcium chloride with citric acid, thereby, inhibit corrosion of the casing 112. This is because citric acid, which is eluted prior to the chloride, covers the inner surface of the casing 112 so that the inner surface of the casing 112 becomes unapproachable for salinity, making it possible to reduce the corrosion rate of metal to a level as slow as tap water.

Next, a fuel pack 140 in accordance with a sixth embodiment will be described. Here, members that are the same as those of the first to fifth embodiments are represented by the same reference numerals, and the description thereof is omitted.

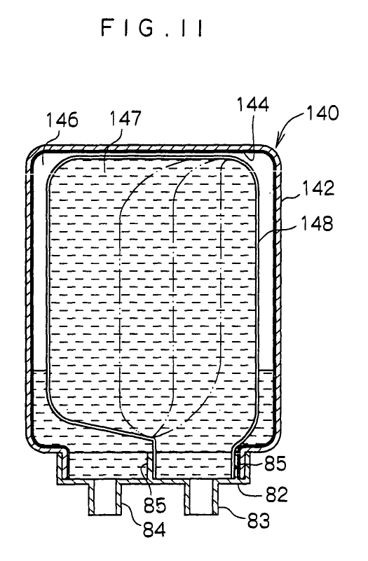

As shown in FIG. 11, the interior of a casing 142 of the fuel pack 140 is coated with a coating 144 that is made from an antifreezing agent composed of a freezing-point depressant and a thickener. For this reason, even in a cold district having temperatures lower than the freezing point, water, which is recovered from the fuel cell 12 (see FIG. 3), does not freeze because of the coating 144. Therefore, water stored in a discharged-solution storing section 146 can be taken out therefrom, and a sufficient space is maintained for a fuel storing section 147 inside a fuel bag body 148. Thus, the fuel pack 140 can be used continuously.

Next, a fuel cell system 150 in accordance with a seventh embodiment will be described. Here, members that are the same as those of the first to sixth embodiments are represented by the same reference numerals, and the description thereof is omitted.

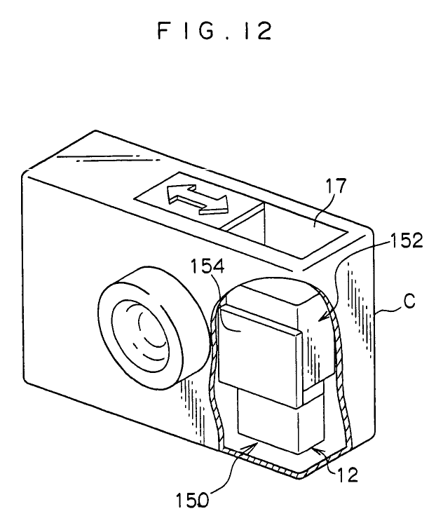

As shown in FIG. 12, a heater 154 is disposed to face a fuel pack 152 in the housing section 17 of the digital camera C. The heater 154 heats the water stored in a discharged-solution storing section (not shown), thereby, preventing water, which is recovered into the discharged-solution storing section, from being frozen, even when using the camera C in a cold district having temperatures lower than the freezing point. Consequently, water stored in the discharged-solution storing section can be taken out therefrom, and a sufficient space is maintained for fuel to be refilled in the fuel pack 152 so that it is possible to continuously use the digital camera C.

Note that, the heater 154 may be adapted to heat the fuel cell 12, so that chemical reaction is accelerated in the fuel cell 12 to carry out power generation, even though the fuel cell 12 is a type of a fuel cell which cannot generate power in cold districts.

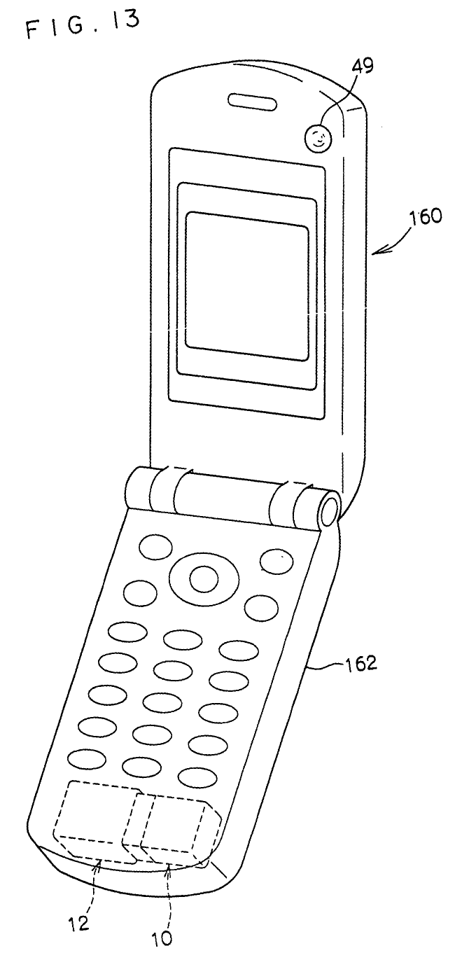

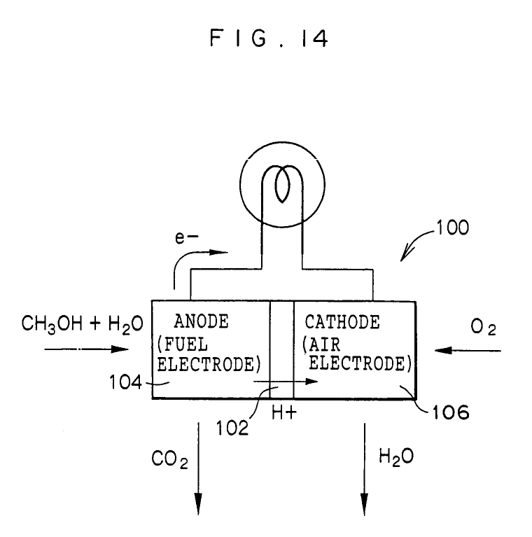

It should be noted that, in the present embodiments, a digital camera was used as a example. However, the invention can be applicable to other portable devices and portable terminals such as analog cameras, notebook personal computers and portable telephones. As shown in FIG. 13, in a case of the application to a portable telephone 160, which is provided with a camera having an image-pickup unit 49 constituted by a shutter and a lens, the fuel pack 10 and the fuel cell 12 may be placed on the side of a keyboard box 162.

Moreover, a direct methanol fuel cell has been exemplified. However, the invention may be applied to fuel cells of other types.

The invention, which is provided with the above-mentioned arrangement, makes it possible to prevent a by-product generated in a fuel cell from leaking as well as being frozen, and also to prevent wasteful consumption of the fuel.

What is claimed is:

1. A fuel cell system comprising:
a fuel cell; and
a fuel pack including:
a fuel storing section for storing a fuel for generating power by the fuel cell,
a fuel supply port which is provided in the fuel storing section, and is connected to a solution supply port of a fuel electrode of the fuel cell,
a discharged-solution storing section for storing solution discharged from the fuel cell,
a discharged-solution recovery port which is provided in the discharged-solution storing section, and is connected to a solution discharge port of an air electrode of the fuel cell, and
a sheet member which is deformable, and which separates the fuel storing section and the discharged-solution recovery section from each other,
wherein a secondary cell which stores power generated by the fuel cell is installed.

2. A fuel cell system according to claim 1, wherein an antifreezing agent is provided in the discharged-solution storing section.

3. A fuel cell system according to claim 2, wherein the antifreezing agent is filled into the discharged-solution storing section.

4. A fuel cell system according to claim 2, wherein the antifreezing agent is applied to coat the discharged-solution storing section.

5. A fuel cell system according to claim 2, wherein a desiccant is filled into the discharged-solution storing section.

6. A fuel cell system according to claim 5, further comprising a discharged-solution bag into which the desiccant is filled wherein the discharged-solution storing section is formed by detachably attaching an opening portion of the discharged-solution bag to the discharged-solution recovery port.

7. A fuel cell system according to claim 1, wherein the sheet member comprises a flexible material.

8. A fuel cell system according to claim 1, wherein the sheet member comprises an alcohol resistant material.

9. A fuel cell system according to claim 1, wherein the fuel storing section is formed from a bag body, and a flexible casing which comprises the fuel supply port and the discharged-solution recovery port, houses the bag body, and forms the discharged-solution storing section placed on the outside of the bag.

10. A fuel cell system according to claim 9, further comprising a heating mechanism which heats at least one of the discharge solution stored in the discharged-solution storing section and the discharged solution stored in the casing.

11. A fuel pack comprising:
a fuel bag body which stores a fuel to be used for generating power in a fuel cell;
a fuel supply port which is provided at an opening portion of the fuel bag body, and connected to a solution supply port of a fuel electrode of the fuel cell;
a flexible casing that houses the fuel bag body storing the fuel; and
a discharged-solution recovery port which is provided at the casing, and connected to a solution discharge port of an air electrode of the fuel cell.

12. A fuel pack according to claim 11, wherein a desiccant is filled into the casing.

13. A fuel pack according to claim 12, further comprising a discharge solution bag which is housed in the casing with an opening portion thereof being detachable attached to the discharged-solution recovery port, and into which the desiccant is filled.

14. A fuel pack according to claim 11, wherein the casing is provided with an antifreezing agent.

15. A fuel pack comprising:
a fuel storing section for storing a fuel for generating power by a fuel cell;
a fuel supply port which is provided in the fuel storing section, and is connected to a solution supply port of a fuel electrode of the fuel cell;
a discharged-solution storing section for storing solution discharged from the fuel cell;
a discharged-solution recovery port which is provided in the discharged-solution storing section, and is connected to a solution discharge port of an air electrode of the fuel cell; and
a sheet member which is deformable, and which separates the fuel storing section and the discharged-solution recovery section from each other,
wherein a desiccant is filled into the discharged-solution storing section.

16. A fuel pack according to claim 15, further comprising a discharged-solution bag into which the desiccant is filled wherein the discharged-solution storing section is formed by detachably attaching an opening portion of the discharged-solution bag to the discharged-solution recovery port.

17. A fuel pack comprising:
a fuel storing section for storing a fuel for generating power by a fuel cell;
a fuel supply port which is provided in the fuel storing section, and is connected to a solution supply port of a fuel electrode of the fuel cell;
a discharged-solution storing section for storing solution discharged from the fuel cell;
a discharged-solution recovery port which is provided in the discharged-solution storing section, and is connected to a solution discharge port of an air electrode of the fuel cell; and
a sheet member which is deformable, and separates the fuel storing section and the discharged-solution recovery section from each other,
wherein the discharged-solution storing section is provided with an antifreezing agent.

18. A fuel pack according to claim 17, wherein the antifreezing agent is filled into the discharged-solution storing section.

19. A fuel pack according to claim 17, wherein the antifreezing agent is applied to coat the discharged-solution storing section.

20. A fuel pack according to claim 17, wherein the sheet member comprises a flexible material.

21. A camera comprising a solution supply port for a fuel electrode of a fuel cell and a solution discharge port for an air electrode of the fuel cell, wherein the fuel pack of claim 1 is installed.

22. A portable telephone having a camera that comprises a solution supply port for a fuel electrode of a fuel cell and a solution discharge port for an air electrode of the fuel cell, wherein the fuel pack of claim 1 is installed.

23. A portable terminal comprising a solution supply port for a fuel electrode of a fuel cell and a solution discharge port for an air electrode of the fuel cell, wherein the fuel pack of claim 1 is installed.
